(19) United States
(12) Patent Application Publication
(10) Pub. No.: US 2008/0216328 A1
(43) Pub. Date: Sep. 11, 2008

(54) HAND GUARD FOR USE WITH SAWS

(76) Inventor: Ryan Adkins, Huntington, WV (US)

Correspondence Address: MCNEES WALLACE & NURICK LLC, 100 PINE STREET, P.O. BOX 1166, HARRISBURG, PA, 17108-1166, US

(21) Appl. No.: 11/683,594

(22) Filed: Mar. 8, 2007

(51) Int. Cl. B27B 21/00

(52) U.S. Cl. 30/514

(57) ABSTRACT

A saw and hand guard system is provided. This system includes: a hand-operated saw, wherein the saw further includes a handle having a rear portion and a front portion, and wherein the rear portion is adapted to receive a user's hand; and a hand guard adapted to be mounted on the front portion of the handle, wherein the hand-guard further includes: a durable, rigid plate, wherein the plate further includes a single piece of material, and wherein the single piece of material is shaped to provide at least two distinct protective surfaces; at least one bracket attached to or formed integrally with the plate for detachably mounting the plate on the front portion of the handle; and at least one connector, wherein the at least one connector cooperates with the at least one bracket for mounting the hand-guard on the front portion of the handle.

### BACKGROUND OF THE INVENTION

The described invention relates generally to a hand and finger protection system for use with hand-operated saws, and more specifically to an easily attachable and detachable hand and finger guard for use with saws, hacksaws and the like.

The hacksaw is a common tool used for sawing or cutting through metal, plastic, and other particularly hard materials. Hacksaws typically include a handle, often of a pistol-grip type, which is attached to one end of a frame that is used to support a saw blade. The user of a hacksaw grips the handle firmly and usually exerts considerable force on both the saw and the material being cut with the saw. As the process of sawing through material such as metal or hard plastic proceeds, sharp and/or jagged edges are often formed on the material being cut. A forceful forward stroke of the hacksaw may bring the hand and fingers of the user into direct contact with these sharp and/or jagged edges, thereby creating a significant risk for debilitating injury. While some hacksaw hand guards have been disclosed in the art, these devices are not necessarily viable in a commercial sense because they are too mechanically complex, are limited to use with specific types of saws, or because they substantially block the view of the user, making it difficult to clearly see the material being cut. Thus, there is an ongoing need for an effective, inexpensive, and easily-used hand and finger guard for use with saws, and hacksaws in particular.

### SUMMARY OF THE INVENTION

The following provides a summary of exemplary embodiments of a hand and finger guard for use with saws, according to the present invention. This summary is not an extensive overview and is not intended to identify key or critical aspects or elements of the present invention or to delineate its scope.

In accordance with one aspect of the present invention, a saw and hand guard system is provided. An exemplary embodiment of this system includes: a hand-operated saw, wherein the saw further includes a handle having a rear portion and a front portion, and wherein the rear portion is adapted to receive a user's hand; and a hand guard adapted to be mounted on the front portion of the handle. The hand-guard further includes: a durable, rigid plate, wherein the plate further includes a single, unitary piece of material, and wherein the single piece of material is formed, shaped, or fabricated to provide at least two distinct protective surfaces; at least one bracket attached to or formed integrally with the plate for detachably mounting the plate on the front portion of the handle; and at least one connector, wherein the at least one connector cooperates with the at least one bracket for mounting the hand-guard on the front portion of the handle.

In accordance with another aspect of the present invention, a safety system for use with saws or other tools is provided. An exemplary embodiment of this system includes: a hand-operated saw, wherein the saw further includes a handle having at least a rear portion and a front portion, and wherein the rear portion is adapted to receive a user's hand; and a detachable hand-guard device mountable on the front portion of the handle in either a right-handed orientation or a left-handed orientation. The hand-guard device further includes: an impact resistant plate, wherein the plate further includes a single piece of material, and wherein the single piece of material is contoured or otherwise shaped to provide multiple protective surfaces; at least two substantially C-shaped brackets affixed to or formed integrally with the plate, wherein the at least two brackets are each adapted to receive the front portion of the handle; and at least two quick-release connectors, wherein the at least two quick release connectors cooperate with the at least two brackets for detachably mounting the hand-guard on the front portion of the handle of the hand-operated saw.

In yet another aspect of this invention, a hand and finger guarding device for use with hand-operated saws is provided. This device includes: a hand and finger guarding device for use with hand-operated saws, comprising: a durable, rigid plate, wherein the plate further includes a single piece of material, and wherein the single piece of material is shaped to provide at least two distinct protective surfaces; at least one mounting bracket attached to or formed integrally with the plate; and at least one connector, wherein the at least one connector is adapted to cooperate with the at least one mounting bracket for detachably mounting the hand and finger guarding device on a hand-operated saw.

Additional features and aspects of the present invention will become apparent to those of ordinary skill in the art upon reading and understanding the following detailed description of the exemplary embodiments. As will be appreciated by the skilled artisan, further embodiments of the invention are possible without departing from the scope and spirit of the invention. Accordingly, the drawings and associated descriptions are to be regarded as illustrative and not restrictive in nature.

### BRIEF DESCRIPTION OF THE DRAWINGS

The accompanying drawings, which are incorporated into and form a part of the specification, schematically illustrate one or more exemplary embodiments of the invention and, together with the general description given above and detailed description given below, serve to explain the principles of the invention, and wherein:

FIG. 1 is a rear perspective view of an exemplary embodiment of the present invention illustrating proper positioning of the hand guard on a saw for use by a right-handed individual.

FIG. 2 is a side view of the exemplary embodiment of FIG. 1.

FIG. 3 is a side view of an exemplary embodiment of the hand guard device of the present invention illustrating the proper attachment of the device to the front portion of the handle of a saw.

FIG. 4 is a front perspective view of an exemplary embodiment of the hand guard device of the present invention shown detached from a saw.

FIG. 5 is a rear perspective view of an exemplary embodiment of the hand guard device of the present invention shown detached from a saw.

### DETAILED DESCRIPTION OF THE INVENTION

Exemplary embodiments of the present invention are now described with reference to the Figures. Reference numerals are used throughout the detailed description to refer to the various elements and structures. In other instances, well-known structures and devices are shown in block diagram form for purposes of simplifying the description. Although the following detailed description contains many specifics for the purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention.

The present invention relates to a safety system for use with hand-operated cutting tools. As previously indicated, a first general embodiment of this invention provides a saw and hand guard system; a second general embodiment of this invention provides a safety system for use with saws; and a third general embodiment of this invention provides a hand and finger guarding device for use with hand-operated saws such as hacksaws. With reference now to the Figures, one or more specific embodiments of this invention shall be described in greater detail.

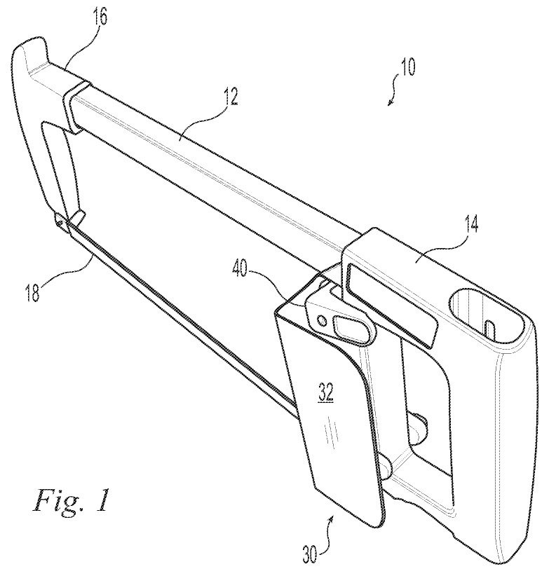

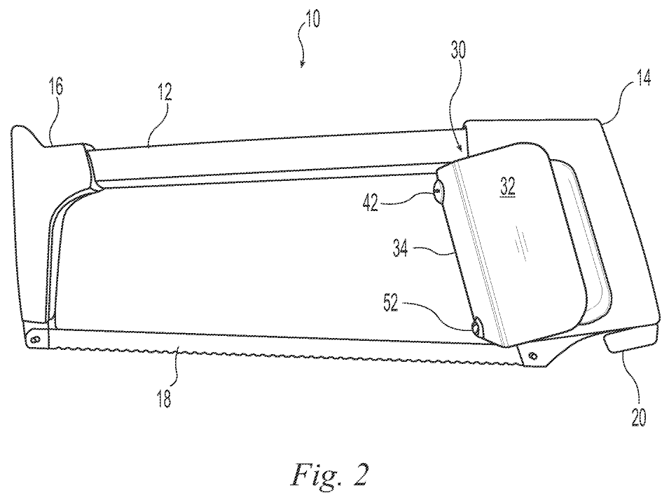

FIGS. 1-5 provide various illustrative views of certain exemplary embodiments of the present invention. In this embodiment, saw safety system 10 includes a hacksaw and detachable hand guard 30. The hacksaw includes top frame portion 12, handle 14, which is attached to the rear of frame portion 12, front frame portion 16, and saw blade 18. A tension creating device (not shown) is typically housed within handle 14 for placing proper tension on saw blade 18. The tension creating device is operated by tightening or loosening actuator 20. In this embodiment of system 10, handle 14 includes a rear portion adapted to receive the hand of a user of the saw and a front portion upon which hand guard 30 is detachably mounted.

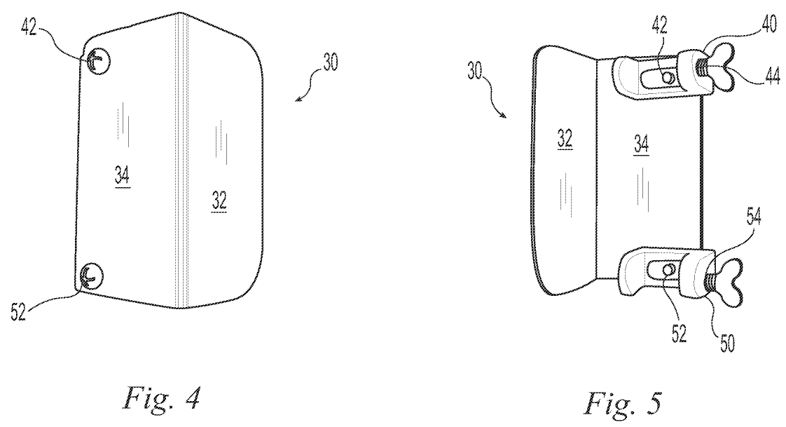

As best shown in FIGS. 4-5, an exemplary embodiment of hand guard 30 includes a durable, rigid, impact-resistant plate that further includes a first protective surface 32 and a second protective surface 34. When properly positioned on a saw, first protective surface 32 faces outward away from the saw (i.e., substantially parallel to blade 18) and second protective surface 34 faces forward toward the front end of the saw (i.e., substantially perpendicular to blade 18). In this embodiment, these two protective surfaces are set at a substantially right angle relative to one another and provide effective protection to the hand and fingers of the user of the saw when the saw is in use. As shown in FIG. 5, mounting brackets 40 and 50 are attached to the plate portion of hand guard 30 by bolts 42 and 52 respectively. In some embodiments of this invention, the mounting brackets are formed integrally with the impact-resistant plate, making bolts 42 and 52 unnecessary. In still other embodiments, additional mounting brackets are included for enhancing the stability of hand guard 30 when mounted on handle 14 and/or for permitting hand guard 30 to be used with a variety of saws and handles. As will be appreciated by the skilled artisan, the plate portion of hand guard 30, as well as mounting brackets 40 and 50 may be manufactured or fabricated from metal, high-impact plastic, polymer, or any other suitably rigid and durable material. A variety of shapes, sizes, and contours are possible for the impact-resistant plate portion of hand guard 30 and additional protective surfaces may be formed on the plate if warranted by particular applications of system 10.

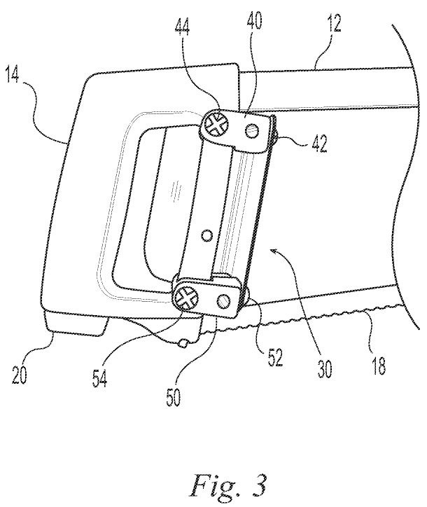

Mounting brackets 40 and 50, which are typically C-shaped brackets, are attached to the front portion of handle 14 by connectors 44 and 54 respectively (see FIG. 3). A substantially C-shaped channel formed in each mounting bracket is adapted to receive the front portion handle of 14. In the exemplary embodiment, connectors 44 and 54 are phillips-head bolts that may be tightened onto handle 14 with a screwdriver or the like. In other embodiments, connectors 44 and 54 are quick release connectors and/or hand-tightened devices that permit the user of hand guard 30 to quickly and easily remove, install, or reposition hand guard 30 on handle 14. As shown in FIG. 5, the quick-release and/or hand-tightened connectors may include grasping means on one end thereof. Advantageously, hand guard 30 may be used by both right-handed and left-handed individuals. To change the position/orientation of hand guard 30 on handle 14, the user simply releases connectors 44 and 54, removes hand guard 30, flips the device over, and re-mounts hand guard 30 on handle 14 in the desired position or orientation.

While the present invention has been illustrated by the description of exemplary embodiments thereof, and while the embodiments have been described in certain detail, it is not the intention of the Applicant to restrict or in any way limit the scope of the appended claims to such detail. Additional advantages and modifications will readily appear to those skilled in the art. Therefore, the invention in its broader aspects is not limited to any of the specific details, representative devices and methods, and/or illustrative examples shown and described. Accordingly, departures may be made from such details without departing from the spirit or scope of the applicant's general inventive concept.

What is claimed:

1) A saw and hand guard system, comprising:
(a) a hand-operated saw, wherein the saw further includes a handle having a rear portion and a front portion, and wherein the rear portion is adapted to receive a user's hand; and
(b) a hand guard adapted to be mounted on the front portion of the handle, wherein the hand guard further includes:
(i) a durable, rigid plate, wherein the plate further includes a single piece of material, and wherein the single piece of material is shaped to provide at least two distinct protective surfaces;
(ii) at least one bracket attached to or formed integrally with the plate for detachably mounting the plate on the front portion of the handle; and
(iii) at least one connector, wherein the at least one connector cooperates with the at least one bracket for mounting the hand-guard on the front portion of the handle.

2) The system of claim 1, wherein the hand-operated saw is a hacksaw.

3) The system of claim 1, wherein the hand guard is mountable on the handle in either a right-handed orientation or a left-handed orientation.

4) The system of claim 1, wherein the durable, rigid plate is manufactured from metal, high-impact plastic, or polymer.

5) The system of claim 1, wherein the at least two distinct protective surfaces further include a forward facing protective surface and a sideways facing protective surface, and wherein the two surfaces are substantially at a right angle relative to one another.

6) The system of claim 1, wherein the at least one bracket is substantially C-shaped for engaging the front portion of the handle.

7) The system of claim 1, wherein the at least one connector further comprises a bolt that may be hand-tightened onto the front portion of the handle.

8) A safety system for use with saws, comprising:
(a) a hand-operated saw, wherein the saw further includes a handle having a rear portion and a front portion, and wherein the rear portion is adapted to receive a user's hand; and
(b) a detachable hand-guard device mountable on the front portion of the handle in either a right-handed orientation or a left-handed orientation, wherein the hand-guard device further includes:
(i) an impact resistant plate, wherein the plate further includes a single piece of material, and wherein the single piece of material is contoured to provide a plurality of protective surfaces;
(ii) at least two substantially C-shaped brackets affixed to or formed integrally with the plate, wherein the at least two brackets are each adapted to receive the front portion of the handle; and
(iii) at least two quick-release connectors, wherein the at least two quick release connectors cooperate with the at least two brackets for detachably mounting the hand-guard on the front portion of the handle of the hand-operated saw.

9) The system of claim 8, wherein the hand-operated saw is a hacksaw.

10) The system of claim 8, wherein the impact resistant plate is manufactured from metal, plastic, or polymer.

11) The system of claim 8, wherein the multiple protective surfaces further include a protective surface perpendicular to the saw and at least one protective surface parallel to the saw.

12) The system of claim 8, wherein the quick-release connectors each further comprises a bolt that may be hand-tightened.

13) A hand and finger guarding device for use with hand-operated saws, comprising:
(a) a durable, rigid plate, wherein the plate further includes a single piece of material, and wherein the single piece of material is shaped to provide at least two distinct protective surfaces;
(b) at least one mounting bracket attached to or formed integrally with the plate; and
(c) at least one connector, wherein the at least one connector cooperates with the at least one mounting bracket for detachably mounting the hand and finger guarding device on a hand-operated saw.

14) The device of claim 13, wherein the hand-operated saw is a hacksaw.

15) The device of claim 13, wherein the device many be attached to a saw in either a right-handed orientation or a left-handed orientation.

16) The device of claim 13, wherein the durable, rigid plate is manufactured from metal, plastic, or polymer.

17) The device of claim 13, wherein the at least two distinct protective surfaces further include a forward facing protective surface and at least one sideways facing protective surface, and wherein the protective surfaces are substantially at right angles relative to one another.

18) The device of claim 13, wherein the at least one mounting bracket is substantially C-shaped for engaging the front portion of the handle.

19) The device of claim 13, wherein the at least one connector further comprises a hand-tightened bolt.

20) The device of claim 19, wherein the bolt further comprises a grasping means on one end thereof for hand-tightening the bolt.
